(19) United States
(12) Patent Application Publication
(10) Pub. No.: US 2024/0295033 A1
(43) Pub. Date: Sep. 5, 2024

(54) A Process and System for Producing Hydrogen

(71) Applicant: Volt Power Group Limited, Western Australia (AU)

(72) Inventor: Tim BANNER, Henderson (AU)

(21) Appl. No.: 18/275,695

(22) PCT Filed: Feb. 25, 2022
(86) PCT No.: PCT/AU2022/050157

§ 371 Date: Aug. 3, 2023

(30) Foreign Application Priority Data
Aug. 24, 2021 (AU) 2021221481
Oct. 6, 2021 (AU) 2021245159

(51) Int. Cl. C25B 1/04; F02C 6/18

(52) U.S. Cl. CPC C25B 1/04; F02C 6/18; F05D 2220/60

(57) ABSTRACT

A process for producing hydrogen comprises the steps of: operating a prime mover, operation of the prime mover producing an exhaust gas; recovering heat from said exhaust gas by a waste heat to power system to produce electricity; and using the electricity to conduct electrolysis of water to produce hydrogen and oxygen. The waste heat to power system is advantageously an ORC power generation system to avoid disadvantages of steam combined cycle operation.

### CROSS REFERENCE TO RELATED APPLICATIONS

This application is a filing under 35 U.S.C. 371 of International Application No. PCT/AU2021/050157, filed Feb. 25, 2022, entitled “A Process and System for Producing Hydrogen,” which claims priority to Australian Patent Application No. 2021245159 filed Oct. 6, 2021 and Australian Patent Application No. 2021221481 filed Aug. 24, 2021, which applications are incorporated by reference herein in their entirety.

### TECHNICAL FIELD

The present invention relates to a process and system for producing hydrogen.

### BACKGROUND ART

The following discussion of the background art is intended to facilitate an understanding of the present invention only. The discussion is not an acknowledgement or admission that any of the material referred to is or was part of the common general knowledge as at the priority date of the application.

Gas pipeline compressor stations, as the name suggests, include compressor(s) for transporting gas through a gas pipeline which typically runs from a gas production location, conventionally following gas processing to remove contaminants such as carbon dioxide, to a gas use location including, for example, use for industrial purposes or for production of electricity to supply an electricity grid. A plurality of gas compressor stations are typically required for gas pipelines, which may run a considerable distance, for example the Dampier Bunbury Pipeline (DBP) running from Dampier to Bunbury in Western Australia.

A gas compressor is driven by a prime mover. Open cycle gas turbines are commonly used as prime movers for gas pipeline compressor stations which are frequently sited in remote locations far from electricity users. This is particularly true of the pipeline network of Western Australia where many of the gas compressor stations are so far from potential electricity users that traditional waste heat to power projects are unviable, not least because connection and supply to electrical grid infrastructure is likely to be a significant additional cost.

Similarly, open cycle gas turbines and gas engines are commonly used for power generation in remote locations where lack of access to water and operations personnel make traditional waste heat to power projects unviable.

Pipeline and power station operators supplying and utilising natural gas have investigated hydrogen blending as a means of partially decarbonising their operations. For hydrogen to contribute towards decarbonisation, it must be produced without CO2 emissions; such production methods include ‘Blue Hydrogen’ which is produced from methane whilst employing Carbon Capture & Storage (CCS) and ‘Green Hydrogen’ which is produced by electrolysis using zero-emission electricity as an energy input.

Blue Hydrogen production methods are limited at present by the developmental status of CCS technology, with several high-profile CCS projects having experienced significant technical challenges.

Green Hydrogen production typically utilises intermittent renewable energy sources such as wind turbines and solar PV installations. Though possible with today's technology, Green Hydrogen is comparatively expensive partially due to the cost of the renewable energy inputs and the fact that intermittent energy sources can only achieve partial utilisation of the associated hydrogen electrolyser(s).

The degree of electrolyser utilisation is limited by the capacity utilisation factors of the renewable energy inputs, capacity utilisation for onshore wind farms is >40% whereas that of solar PV installations is >30% (and more typically >25%). Furthermore, though the costs of wind turbines and solar PV have fallen considerably in the past decade, they remain relatively expensive sources of power especially when their Levelised Costs of Electricity (LCOE) are assessed at traditionally appropriate discount rates. In addition to this, and despite developments in battery technology, renewable energy remains subject to issues of intermittency as wind and solar resources are not ‘always on’ sources of energy.

No matter the method of producing hydrogen, there is a well-known problem in its transport. The processes of compression and cooling to Liquid Hydrogen (“LH2”) or capture of hydrogen as ammonia or organic solvents all imply energetic inefficiencies and costs.

It is an object of the present invention to provide a process and system for producing hydrogen through use of energy produced from waste heat recovery.

### SUMMARY OF INVENTION

With this object in view, the present invention provides—in a first aspect—a process for producing hydrogen comprising the steps of: operating a compressor driven by a prime mover, operation of the prime mover producing an exhaust gas; recovering heat from said exhaust gas by a waste heat to power system to produce electricity; and using said electricity to conduct electrolysis of water to produce hydrogen and oxygen.

In a second aspect, the present invention provides a system for producing hydrogen comprising: a compressor driven by a prime mover, operation of the prime mover providing an exhaust gas; a waste heat to power system for recovering heat from said exhaust gas to produce electricity; and an electrolyser supplied with electricity from the waste heat to power system to conduct electrolysis of water to produce hydrogen and oxygen.

In a third aspect, the present invention provides a system for producing hydrogen comprising: an electricity generator driven by a prime mover, operation of the prime mover providing an exhaust gas; a waste heat to power system for recovering heat from said exhaust gas to produce electricity; and an electrolyser supplied with electricity from the waste heat to power system to conduct electrolysis of water to produce hydrogen and oxygen.

Preferably, the prime mover is an open cycle gas turbine also known as an OCGT. The hot exhaust gas produced by open cycle gas turbines represents a valuable source of waste heat which can be recovered and converted into zero-emission electricity, advantageously on a continuous basis. However, other prime movers producing an exhaust gas, such as reciprocating engines, may also less preferably be used.

The waste heat to power system converts exhaust gas heat to electricity through a suitable power generation system converting heat to mechanical energy or work which is, in turn, converted to electricity, typically in a turbine coupled to a generator. Preferably, the waste heat to power system includes an Organic Rankine Cycle (ORC) power generation system. This represents a departure from the default technology of steam combined cycle for waste heat recovery which has routinely been selected for the achieved thermal efficiency. However, the operational characteristics of steam combined cycle makes this technology unsuitable for remote power generation. This is particularly so for remote and dry locations, such as in the mining regions of central and northern Australia, where the water losses and water balancing requirements of steam combined cycle systems act as significant constraints. Another constraint is the high level of maintenance activity associated with steam combined cycles and the personnel requirements to deliver ongoing maintenance in a remote location.

Alternative power generation systems including, without limitation, supercritical CO2 cycle systems and Kalina cycle systems may be used instead of an ORC power generation system. A steam combined cycle power generation system is avoided for the reasons provided in this specification despite its significant industrial desirability in terms of thermal efficiency and adoption of a low cost working fluid. These systems are expected to be closed loop systems with zero to minimal water losses associated with steam combined cycle power generation systems.

The power generation system may allow for direct heat transfer between prime mover exhaust gas and a working fluid of a power generation system. Alternatively, and preferably, a waste heat recovery unit (WHRU) forming part of the waste heat to power system conveniently allows heat exchange between exhaust gas and a first thermal fluid, preferably a thermal oil, where direct heat exchange with an ORC working fluid is not practically possible due to excessive temperatures and the flammability of the ORC working fluid. A shell and tube heat exchanger is preferred, with tubes of such a heat exchanger being finned to increase heat transfer area. A finned design, by increasing heat transfer area, minimises the volume of the WHRU. A heat exchange system, conveniently including a further heat exchanger or set of heat exchangers, is then provided for exchanging heat between the first thermal fluid and a second thermal fluid.

Conveniently, the second thermal fluid or working fluid for the preferred ORC power generation system is cyclopentane though alternatives (including, without limitation, n-pentane, iso-pentane, n-butane, isobutane, refrigerants, other organic molecules and siloxanes) are available for the ORC power generation system or, indeed a range of power generation systems within the scope of the current disclosure. In the case of cyclopentane, and a range of other potential candidate working fluids, it will be understood that these are flammable and cannot typically be used directly in the WHRU to capture waste heat from high temperature exhaust gas. It will further be understood that alternative working fluids (such as supercritical CO2) may be selected if an alternative to an ORC power generation system is used.

The first thermal fluid is conveniently a thermal oil. The use of thermal oils avoids issues with corrosion, water losses, pressure management and balancing common to steam combined cycle operation.

Where an ORC power generation system is adopted for waste heat to power, as preferred inter alia for the reasons provided above, it may include a single turbine though power generation duty may possibly be split between a plurality of turbines, desirably two turbines. The ORC turbine preferably drives an electricity generator (to at least provide electricity for electrolysis). Where a plurality of ORC turbines is used an individual electricity generator may be provided for each turbine or two turbines may drive a common electricity generator. Where a plurality of ORC turbines is used, the turbines desirably share a common process system which consists of a common pre-heater evaporator, superheater (if required), condenser and circulation pumps plus all associated pipework valves and instruments. The ORC system desirably includes a recuperator and where a plurality of ORC turbines is used each ORC turbine preferably discharges into its own dedicated recuperator which is situated upstream of the common condenser.

The second thermal fluid of the ORC power generation system may be condensed (to remove unusable heat) following expansion by either an air-cooled or water-cooled condenser though other coolants or refrigerants may be used. Air-cooling may be preferred since this technology does not require water, which may be in scarce supply. However, where cooling water is available—either for use as a once-through coolant or as top-up water for an evaporative cooling tower or hybrid air/water cooler, water cooling may be preferred.

The WHRU may be installed within, for example by being formed integral with, an existing exhaust stack for transporting exhaust gas from the prime mover to atmosphere. Alternatively, the WHRU may be installed in parallel to an existing exhaust stack. Installing the WHRU in parallel to the exhaust stack allows the existing exhaust stack to be maintained as a direct exhaust gas path to the atmosphere if the WHRU is unable to receive heat from the exhaust gas. Where the WHRU is formed integral with the existing exhaust stack, the WHRU desirably includes an internal bypass allowing a direct route for discharging exhaust gas to atmosphere—desirably without change in direction of exhaust gas within the exhaust stack—if the WHRU cannot accept heat from the exhaust gas. In any case, the exhaust gas inlet to the WHRU is preferably provided at the bottom of the WHRU. The WHRU is conveniently located in a vertically extending stack.

Electricity produced from the waste heat to power system, preferably an ORC power generation system, is supplied to an electrolyser to enable electrolysis though any excess power can be used for other purposes. The electrolyser may be co-located with the waste heat to power system. Alternatively, the electrolyser may be located at another location, advantageously a hydrogen use location such as a hydrogen fueling location, with electricity being supplied to it through an electricity transmission system. The electrolyser may be fully or partially supplied with electricity from the waste heat to power system. Electrolysis of water produces hydrogen and oxygen through a range of alternative technologies including, without limitation, Proton Exchange Membrane (PEM), Alkaline Electrolysis and Solid Oxide Electrolysis. The electrolyser is desirably dedicated solely to the electrolysis step.

Water should be subjected to pre-treatment, for example by filtration and reverse osmosis, to reduce total dissolved solids and provide demineralised water for delivery to the electrolyser. As electrolysis may be more efficient at higher temperature, the demineralised water may be heated for delivery to the electrolyser. For electrolysis operating most efficiently at higher temperature, for example Solid Oxide or Alkaline electrolysis, heat for heating water may be sourced from a convenient heat source within the system, for example including directly from exhaust gas or from the first thermal fluid, for example as returned from the power generation system, prior to delivery to the WHRU.

In a fourth aspect, the present invention provides a pipeline system comprising: a pipeline for transporting a fluid, such as natural gas, from a fluid production location to a fluid use location; a compressor station for transporting fluid through the pipeline and comprising a compressor driven by a prime mover, operation of the prime mover providing an exhaust gas; a waste heat to power system for recovering heat from said exhaust gas to produce electricity; an electrolyser supplied with electricity from the waste heat to power system to conduct electrolysis of water to produce hydrogen and oxygen; and a hydrogen delivery system for delivering hydrogen to the pipeline.

Advantageously, the hydrogen delivery system allows delivery of hydrogen to the pipeline to be blended with the fluid. Delivery of hydrogen to the pipeline may be by injection. Where blending of hydrogen with fluid is contemplated, the fluid must be compatible with the hydrogen in terms of not causing physical or chemical hazard when the fluid is blended with hydrogen. Conveniently, the fluid is natural gas though other fluids are not excluded. The quantity of hydrogen is relatively small compared to the volume of fluid being transported through the pipeline.

The prime mover, where a gas turbine or gas fueled engine is preferred, may utilise gas from the pipeline as fuel.

In a fifth aspect, the present invention provides a system for producing hydrogen comprising: a prime mover, preferably driving either a compressor or an electricity generator, operation of the prime mover providing an exhaust gas; a waste heat to power system for recovering heat from said exhaust gas to produce electricity; an electrolyser supplied with electricity from the waste heat to power system to conduct electrolysis of water to produce hydrogen and oxygen; and a hydrogen compression, storage and distribution system for separate storage and distribution of high-purity hydrogen product.

The hydrogen compression, storage and distribution system allows the produced hydrogen to be stored and distributed as a separate product for use in high purity hydrogen applications such as zero-emission fuel for equipment such as heavy vehicles, aircraft, industrial equipment or mining equipment. This allows a decarbonised fueling solution that offers significant potential to substantially reduce diesel and other fuel costs.

The proposed system for producing hydrogen can be either a “Greenfield” installation whereby the prime mover, especially a gas turbine, and other sub-systems are installed simultaneously or “Brownfield” whereby the system is retrofitted to an existing prime mover on an existing compressor station or an existing power generation facility.

Amongst other advantages, the process and system for producing hydrogen according to the invention provides pipeline and power station operators with a way to productively utilise waste heat produced by remote facilities, including with limited water availability, by generating cost-effective zero-emission hydrogen advantageously on a continuous basis. There are at least three salient benefits, namely 1) low-cost baseload zero-emission electricity reducing hydrogen production cost; 2) maximisation of electrolyser utilization, further reducing hydrogen cost; and 3) hydrogen delivery to a pipeline or storage and distribution system that is conveniently adjacent to hydrogen production facilities avoiding need for, amongst other things, additional high pressure compression, liquification or chemical transformation for long distance transportation, thereby eliminating associated cost, energy and safety concerns.

### BRIEF DESCRIPTION OF THE DRAWINGS

Further features of the process and system for producing hydrogen of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a: process flow diagram for a process and system for producing hydrogen according to a first embodiment of the present invention.

FIG. 2 is a: process flow diagram for a process and system for producing hydrogen according to a second embodiment of the present invention.

FIGS. 3 and 3a are: process flow diagrams for a process and system for producing hydrogen according to a third embodiment of the present invention.

FIG. 4 is a: process flow diagram for a waste heat to power system included in the process and system of FIGS. 1, 2 and 3.

### DESCRIPTION OF PREFERRED EMBODIMENTS

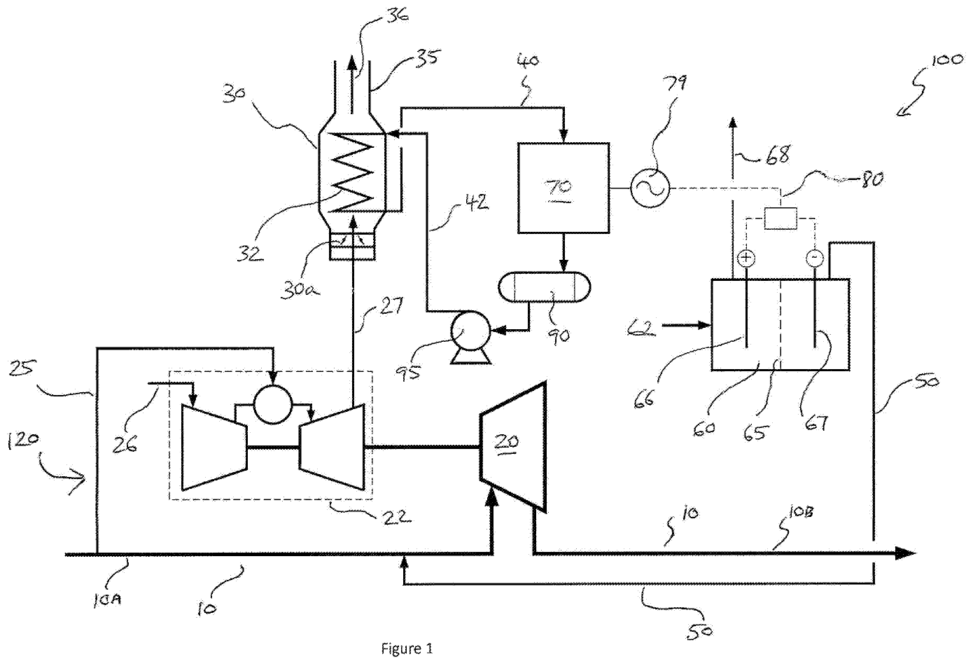

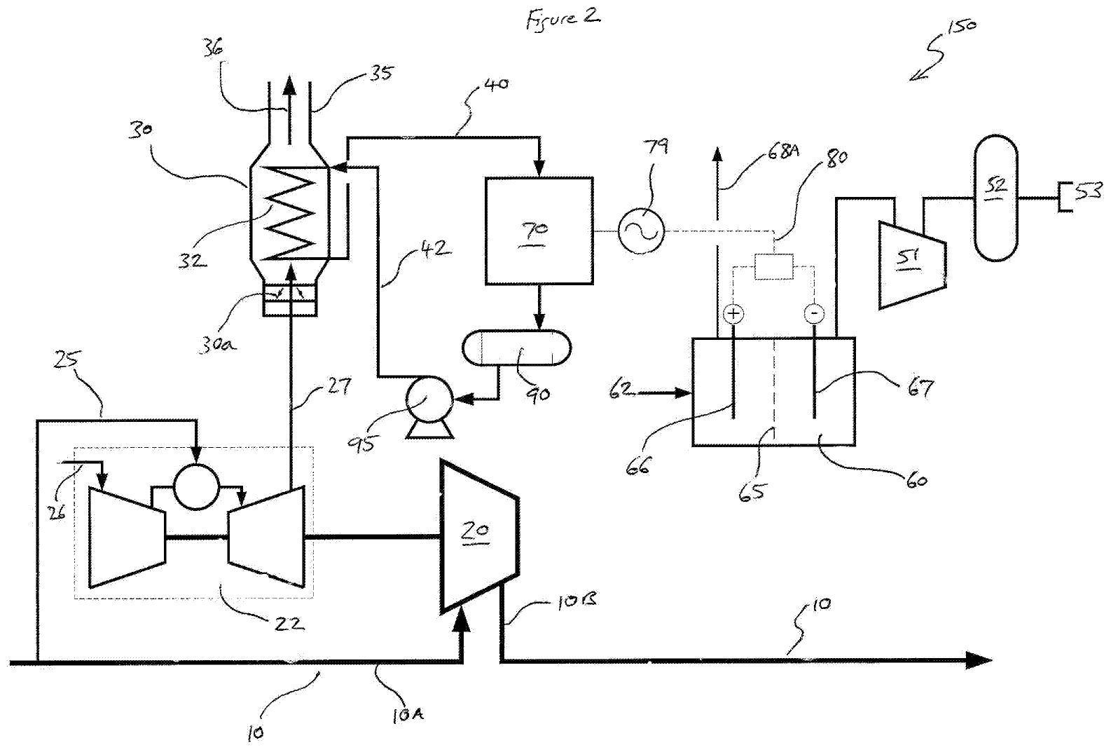

Referring to FIG. 1, schematically shows a system and process 100 for producing hydrogen at a compressor station 120 including a compressor 20 for transporting natural gas through a pipeline 10 from pipeline section 10A to pipeline section 10B with the pipeline 10 transporting natural gas from a natural gas producing location, following natural gas processing for removal of contaminants such as carbon dioxide in a gas purification process, to a natural gas use location, for example supplying an industrial user of natural gas (for example to produce ammonia) or an electricity generator supplying electricity to a grid. Compressor station 120 is located in an arid “off grid” remote location without connection to an external electricity grid so it must be provided with an on site power source. It will be understood that a plurality of compressor stations 120 are arranged along the length of pipeline 10 which may extend a significant distance, for example over 1500 km. An example of pipeline 10 to which process 100 could be applied is the Dampier Bunbury Pipeline. Process and system 100 could be implemented at one or more of the compressor stations 120 along the pipeline 10.

Compressor 20 is driven by an open cycle gas turbine 22 supplied with fuel in the form of natural gas 25 extracted from pipeline section 10A of pipeline 10 at or proximate the compressor station 120. Examples of suitable gas turbines include GE PGT25+ (˜30 MW power rating) and Solar Mars 100 (˜10 MW) gas turbines, with the latter being commonly used in gas compressor stations.

Natural gas 25 is combusted in a turbine combustor with air 26 (though oxygen 68 produced by electrolyser 60 may also be used as an oxidant or for oxygen enrichment of air 25) during operation of the gas turbine 22 to produce an exhaust gas 27 at temperature of about 500° C. Ordinarily, the exhaust gas 27 would simply be vented to atmosphere through vertically extending exhaust stack 35 with loss of utility of a valuable high-grade waste heat resource. Process and system 100 allows this value to be captured and a significant opportunity cost to be avoided.

As the compressor station 120 is situated in an arid remote location, steam turbine combined cycle is not suitable as a waste heat to power system because steam combined cycle systems, despite their industrially recognised advantages as described above, are maintenance and operations intensive as described above. Furthermore, compressor station 120 gas turbines 22 are much smaller than the utility-scale gas turbines that are a common application of steam turbine combined cycles.

Exhaust gas 27 is directed to a waste heat recovery unit (WHRU) 30 containing a heat exchanger 32 being a shell and tube heat exchanger with finned tubes. Exhaust gas 27 flows on the shell side (hot) and heat transfer medium 42 on the tube side (cool).

WHRU 30 is of integral design, being formed within the vertically extending exhaust stack 35 for compressor station 120. Though not shown, an internal bypass is provided to allow a direct route to atmosphere for exhaust gas 27. A diverter valve arrangement 30a is provided at the bottom of WHRU 30 to direct exhaust gas 27 either for heat exchange in heat exchanger 32 or to be vented to atmosphere where heat transfer medium 42 cannot accept heat.

In the illustrated embodiment, diverter valve arrangement 30a directs flow of exhaust gas 27 past the heat exchanger 32 for counter-current heat exchange with cool thermal oil 42 returning from the ORC power generation system 70 which is desirable and preferred in this embodiment, not least because of its low maintenance requirements and capacity to operate reliably without operator intervention to provide baseload power when coupled with an almost continuous heat source in the form of waste heat from gas turbine 22 when in operation. It will be understood that, in some embodiments, ORC power generation system 70 could be substituted with other types of power generation system; for example, a supercritical CO2 cycle system or a Kalina cycle system though avoiding steam combined cycle systems and issues, among other things, of water balancing.

Conveniently, the heat transfer medium is a thermal oil 42. Thermal oils have high stability and low vapour pressure at the required operating temperature of stream 40. Thermal oils are also preferred due to the low maintenance requirements and low design pressure of the heat recovery system in comparison to water/steam systems.

The flow of thermal oil 42 is driven by a pump 95 which is typically a centrifugal-type unit. Thermal oil flow rate may be controlled to achieve a desired level of heat transfer between exhaust gas 27 and thermal oil 42. For this purpose, a feedback control loop may be provided between hot thermal oil 40 temperature and flow rate. An expansion vessel 90 is situated upstream of the pump to provide volume to accommodate thermal expansion.

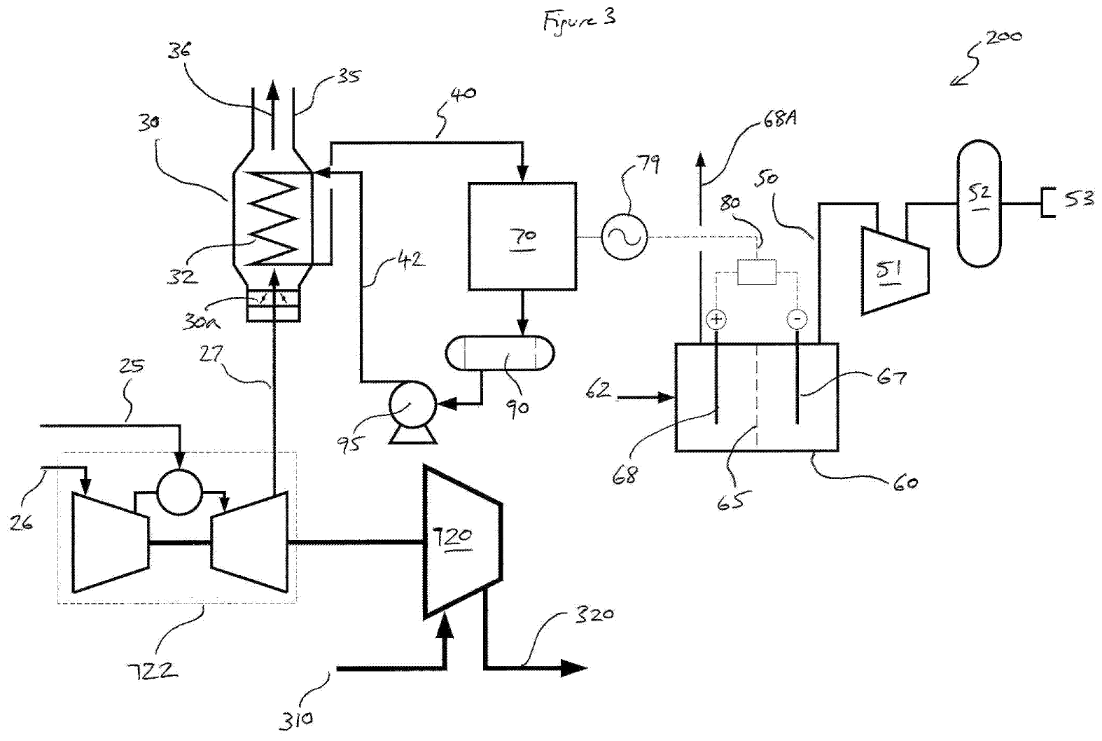

In the illustrated embodiment, cool thermal oil 42 is not the working fluid for the ORC power generation system 70. Thus, the process 100 does not involve direct waste heat recovery from exhaust gas 27 but rather uses an indirect exchange using thermal oil 42 which, on return to the ORC power generation system 70 as heated thermal oil 40, further exchanges heat with the ORC working fluid 77 as shown in FIG. 2. In some embodiments, direct waste heat recovery from exhaust gas 27 to ORC working fluid without use of the first or intermediate thermal oil 40, 42 may be adopted.

Following heat exchange between exhaust gas 27 and thermal oil 42, cooled exhaust gas 36 leaves the WHRU 30 and flows to atmosphere.

Hot thermal oil 40, heated by the exhaust gas 27, carries heat to ORC power generation system 70, where heat is transferred to the second thermal fluid 77, conveniently cyclopentane in this embodiment, the ORC working fluid. Cool thermal oil 42 flows through a return line including an expansion vessel 90 and pump 95 from ORC power generation system 70 to WHRU heat exchanger 32. The design and operation of ORC power generation system 70 is further described below. While cyclopentane is used as working fluid in this embodiment, a working fluid is selected to match the temperature profile of exhaust gas 27. Cyclopentane is useful for this purpose though other organic, including hydrocarbon and non-hydrocarbon, working fluid alternatives are available. Without limitation, suitable alternative ORC working fluids to cyclopentane may be selected from the group consisting of n-pentane, iso-pentane, n-butane, isobutane, refrigerants and siloxanes.

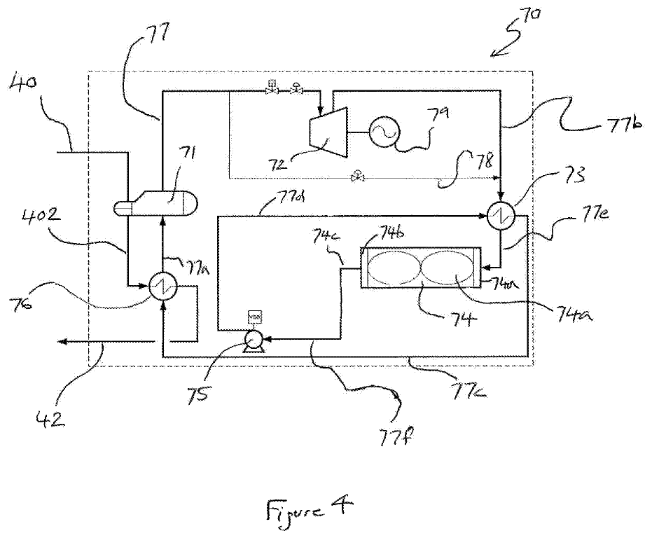

Referring now to FIG. 4, the ORC power generation system 70 will now be described. ORC power generation system 70 embodies a closed-loop thermodynamic process that converts waste heat, as recovered from exhaust gas 27, in the heated first thermal fluid 40, to electricity for powering electrolyser 60.

The ORC working fluid 77, undergoes a series of phase, temperature and volume changes through the various stages of the thermodynamic process (i.e. the Organic Rankine Cycle) and ORC power generation system 70. ORC power generation system 70 includes, in series, a preheater 76, evaporator 71, turbine 72 for driving electricity generator 79, recuperator 73 and condenser 74. Turbine 72 may be bypassed by cyclopentane line 78, if required.

In this embodiment, preheater 76 is a shell and tube heat exchanger with thermal oil 402 flowing on the shell side and cyclopentane 77c flowing through the tubes. The function of preheater 76 is to receive high-pressure cyclopentane 77c in the liquid phase from the recuperator 73 and raise the cyclopentane temperature to its boiling point at the selected operating pressure.

In this embodiment, evaporator 71 is a kettle-type boiler with a tube bundle submerged in liquid cyclopentane 77a.

Recuperator 73 is a shell and tube heat exchanger with low-pressure cyclopentane vapour 77b on the shell side and high-pressure cyclopentane vapour 77d flowing through the tubes.

Condenser 74 is here air-cooled which is desirable for water conservation in an arid location but it will be understood that it may be water-cooled or cooled by another refrigerant. In the air-cooled condenser (ACC) 74 embodiment, cyclopentane flows through a multiple tube bundle of ACC 74 with air flowing over the finned tubes exterior. The ACC 74 may consist of multiple identical modules arranged in parallel with each other. Airflow over the tube bundle is driven by fans. Cyclopentane vapour from the recuperator 73 is distributed between the ACC modules by an inlet header 74a (not shown) which runs across the full length of the ACC. The inlet header 74a acts as a manifold which distributes the cyclopentane vapour into the multiple tube bundles. Each tube bundle flows across the ACC fans to the far side of the air-cooled condenser 74 where condensed liquid cyclopentane is collected in the outlet header 74b. Collection of liquid cyclopentane in the outlet header 74b provides suction head for feed pump 75.

The ORC power generation system 70 operates as follows:
(1) High pressure, saturated cyclopentane in the liquid phase 77a flows to evaporator 71 where heat is exchanged from the thermal oil 40 into the cyclopentane, evaporating the cyclopentane to produce high pressure, high temperature vapour in line 77. Cooled thermal oil 402 flows back via preheater 76 to the heat exchanger 32 of WHRU 30 as cool thermal oil 42. In some embodiments, a superheater (not shown) may be included downstream of the evaporator 71 to further increase the temperature of cyclopentane vapour in line 77.
(2) High pressure, high temperature cyclopentane vapour 77 flows to the expansion turbine 72 where it expands to a low pressure generating rotational motion within the turbine 72 which drives the generator 79 and produces electrical power which is used in the electrolyser 60. Cyclopentane working fluid 77b leaves the turbine 72 as a low pressure, superheated vapour 77b.
(3) Low pressure, superheated cyclopentane vapour 77b flows to recuperator 73 where superheat is removed prior to condensation of the vapour in the ACC 74. The recuperator 73 is an economizer which transfers superheat from the low-pressure cyclopentane 77b into the high pressure cyclopentane liquid 77d before it enters the preheater 76 as high pressure cyclopentane liquid 77c.
(4) Low pressure, low temperature vapour 78e from recuperator 73, flows to condenser 74 where the vapour is cooled further and condenses into the liquid phase, with air providing a heat sink for the condensation process. The cyclopentane leaves the air-cooled condenser 74 as low-pressure liquid cyclopentane 77f.
(5) Low pressure, low temperature liquid cyclopentane 77f flows to pump 75 where its pressure is increased to the ORC cycle high pressure for delivery as high pressure, low temperature liquid cyclopentane 77d to recuperator 73.
(6) High pressure, low temperature cyclopentane liquid 77d flows to the recuperator 73 where heat is transferred to the liquid cyclopentane from the medium temperature cyclopentane vapour 77b flowing from the turbine 72 exhaust. High pressure, medium temperature liquid 77c, heated in recuperator 73, flows to the preheater 76.
(7) High pressure, medium temperature liquid 77c flows to the preheater 76 where its temperature is increased to the boiling point at the operating pressure through heat exchange with the thermal oil 402 leaving the evaporator 71. High pressure, saturated liquid cyclopentane then flows to the evaporator 71, completing the cycle.

The cycle of thermal process stages (1)-(7) continues for as long as the WHRU 30 is coupled with the ORC power generation system 70 to generate power. It will be understood that pipeline 10 typically operates continuously and, similarly, compressor 20 must also operate continuously to transport purified natural gas through pipeline 10 as typically must the waste heat recovery unit 30. It follows that electricity generator 79 can supply electricity 80 continuously to the electrolyser 60 to enable production of hydrogen 50 with baseload power and without the recognised intermittency issues of solar or wind power though, in embodiments, such power sources can be used in combination with power produced by the ORC power generation system 70 to supply electrolyser 60 with power.

It will be understood that the ORC power generation system 70 generates alternating current (AC) electricity where electrolysers typically operate with DC electricity. A rectifier (not shown) is used to convert the AC electrical output from generator 79 to DC electricity 80.

Electrolysis of water in electrolyser 60, in which the respective electrodes serve no other function than for electrolysis, may be achieved by several suitable technologies any of which may be used in process 100. Such suitable electrolysis technologies include Proton Exchange Membrane (PEM), Alkaline electrolysis and Solid Oxide electrolysis. In some embodiments, the most economic electrolyser type is preferred, for example alkaline electrolysis. Electrolyser 60 may, for example, be operated at a pressure of approximately 3000 kPa(g).

Hydrogen 50 is produced by electrolysis of water 62 at the cathode 67 of electrolyser 60 powered by electricity 80 generated from waste heat recovered from exhaust gas 27 by the Organic Rankine Cycle (ORC) power generation system 70. As electricity 80 is generated continuously, for the reasons described above, the consequence is a lower production cost for hydrogen 50 than for hydrogen produced from electricity generated from intermittently available renewable resources such as solar and wind power.

Hydrogen 50, produced in electrolyser 60, has high purity, with a purity as high as 99.998% (on a molar basis) with oxygen and nitrogen contents being, for example, 2 ppm and 12 ppm, respectively.

Hydrogen 50 is captured and delivered, in controlled proportion, to pipeline section 10A of pipeline 10 for blending with natural gas. Delivery of hydrogen 50 to pipeline 10 is desirably by injection. Where the electrolyser 60 pressure is 3000 kPa(g) and the pipeline 10 operating pressure (suction pressure) upstream of the compressor 20 is less than 3000 kPa(g), hydrogen may be injected directly into pipeline 10 without need for compression. If, however, the suction pressure is greater than 3000 kPa(g) or if there is an insufficient pressure differential between the hydrogen 50 pressure and the compressor suction pressure, then a hydrogen booster compressor (not shown) may be required downstream of the electrolyser 60 to achieve the pressure required to inject hydrogen 50 into the pipeline 10. The quantity of hydrogen 50 produced is expected to be very small in comparison to the quantity of natural gas transported by pipeline 10. Therefore, it is expected that the resulting hydrogen-natural gas blend will be well within the design tolerances of the pipeline 10 and compressor station 120.

Alternatively, or additionally in some cases, hydrogen 50 may be blended with the fuel gas stream 25 to the gas turbines 22 and consumed at site, offsetting natural gas fuel consumption at the compressor station 120.

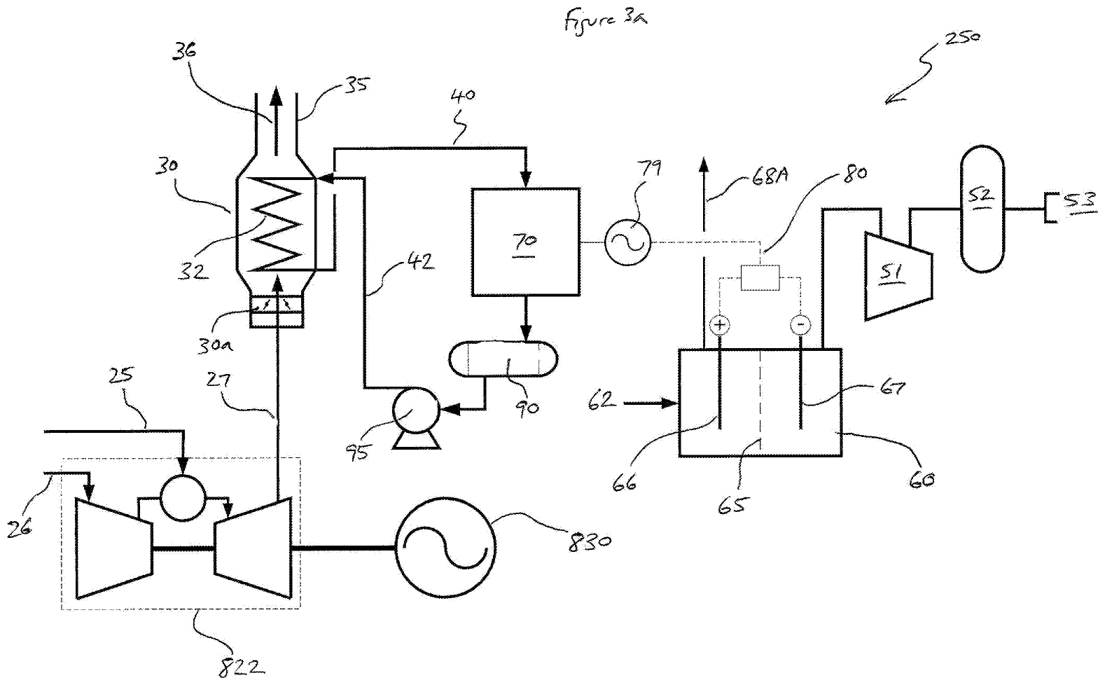

Oxygen is also produced at the anode 66 of electrolyser 60, an anode compartment being separated from the cathode 67 compartment by a suitable membrane 65, and this oxygen may be stored at 3000 kPa(g), the electrolyser 60 pressure, and/or exported from the compressor station 120 site if demand exists. Oxygen 68 can also be used as oxidant for the gas turbine 22 combustor, directed as oxygen stream 68A to storage or export (FIGS. 2 to 3a) or vented 68 directly to atmosphere with no environmental impact (FIG. 1).

Water 62 should be demineralised for electrolysis and is, in this embodiment, pre-treated by filtration and reverse osmosis 9 (not shown), to reduce total dissolved solids (from a likely brackish or saline water source) prior to delivery to the electrolyser 60. The electrolysis process may be more efficient at elevated temperatures. In this case, heat can be sourced from elsewhere in the process 100, preferably the cool thermal oil 42 returned from ORC power generation system 70, this heat being optionally used to preheat demineralised water prior to delivery to electrolyser 60. A further alternative source of heat for heating water 62 is exhaust gas 27.

Referring now to FIG. 2, there is shown a process 150 in which hydrogen 50, produced according to the principles described above for process 100, may be further compressed by compressor 51 and stored in storage vessel 52 with a hydrogen fuel offtake 53 to supply hydrogen for use in high-purity applications such as for zero-emission fuel in heavy vehicles, industrial or mining equipment or aircraft.

Referring now to FIGS. 3 and 3a, the prime mover, in the form of respective open gas cycle turbines 722 and 822 of the illustrated processes 200 and 250, either drives a compressor 720 (FIG. 3) compressing stream 310 to higher pressure stream 320; or drives an electricity generator 830 (FIG. 3a). In these circumstances, the produced hydrogen—the hydrogen production process following the same principles as described above with reference to FIGS. 1 and 2—cannot be blended with a pipeline gas stream and hydrogen 50 is compressed by compressor 51 and stored in storage vessel 52 with a hydrogen fuel offtake 53 to supply hydrogen for use in high-purity applications such as for zero-emission fuel in heavy vehicles, industrial or mining equipment or aircraft. This offers substantial savings on diesel and other fuels currently used in these applications.

The combination of a prime mover gas turbine 22 producing high-temperature exhaust gas 27 with an ORC power generation system 70 offers a high-value zero-emission alternative to intermittent solar and wind generation. It is expected that electricity production costs will have a levelised cost of energy (LCOE) lower than for a comparable PV solar option when calculated using a discount rate of 8% over a project lifespan of 25 years. This is primarily due to the comparatively high energy density of waste heat resources compared to the dilute nature of solar and wind resources.

Amongst other advantages, the process and system for producing hydrogen according to the invention enables pipeline, power station and compressor operators with a way to productively utilise waste heat produced by remote compressor stations or power stations 120 by generating cost-effective zero-emission hydrogen 50. There are three salient benefits, namely 1) low-cost baseload zero-emission electricity reducing hydrogen production cost; 2) maximisation of electrolyser utilisation, further reducing hydrogen production cost; and 3) hydrogen delivery to a pipeline or storage facility conveniently adjacent to hydrogen production facilities producing hydrogen at relatively low pressure avoiding need for, amongst other things, high pressure compression, liquification or chemical transformation required for long-distance transportation, thereby eliminating associated cost, energy and safety concerns.

Further, systems of embodiments of the invention may advantageously utilise waste heat recovery for producing electricity—potentially at base load dependent on prime mover operating conditions—to be used for electrolysis and production of hydrogen to be used as a fuel reducing consumption of alternative fuels such as diesel and at a lower cost than hydrogen produced using electricity derived from renewable resources such as wind and solar energy though, if available, electricity derived from such sources may be utilised as an intermittent source of power for electrolysis. The proportion of base load to intermittent power may be selected to achieve desired efficiencies, including economic efficiencies. As an example, the waste heat to power system could provide 20% of power requirements and the intermittent source of power could provide 80% of power requirements.

Systems of embodiments of the invention are not limited to waste heat recovery at gas compressor stations and embodiments may advantageously relate to waste heat recovery from hot exhaust gases, including from open cycle gas turbines generally. Electricity supply would typically also be more consistent, potentially at base load, than through production based on wind and solar energy which are subject to intermittency and grid stability issues.

Modifications and variations to the process and system for producing hydrogen as described in this specification may be apparent to skilled readers of this disclosure. Such modifications and variations are deemed within the scope of the present invention. For example, the process and system for producing hydrogen as described may be used at locations other than gas compressor stations.

Throughout this specification, unless the context requires otherwise, the word “comprise” or variations such as “comprises” or “comprising”, will be understood to imply the inclusion of a stated integer or group of integers but not the exclusion of any other integer or group of integers.

1-25. (canceled)

26. A system for producing hydrogen comprising:
an electricity generator driven by a prime mover, operation of the prime mover providing an exhaust gas;
a waste heat to power system for recovering heat from said exhaust gas to produce baseload electricity; and
an electrolyser supplied with said baseload electricity from the waste heat to power system to conduct electrolysis of water to produce hydrogen and oxygen
wherein the waste heat to power system is selected from the group consisting of an Organic Rankine Cycle (ORC) power generation system, supercritical CO₂ power generation system and Kalina power generation system.

27. The system of claim 26, wherein the waste heat to power system is an Organic Rankine Cycle (ORC) power generation system.

28. The system of claim 26, wherein the prime mover is an open cycle gas turbine.

29. The system of claim 28, wherein the waste heat to power system allows for direct heat transfer between prime mover exhaust gas and a working fluid of a power generation system.

30. The system of claim 29, wherein a waste heat recovery unit (WHRU) forming part of the waste heat to power system allows heat exchange between exhaust gas and a first thermal fluid, preferably a thermal oil.

31. The system of claim 30, wherein the waste heat to power system includes a heat exchange system for exchanging heat between the first thermal fluid and a second thermal fluid.

32. The system of claim 31, wherein the second thermal fluid or working fluid for the ORC power generation system is selected from the group consisting of cyclopentane, n-pentane, iso-pentane, n-butane, isobutane, refrigerants, other organic molecules and siloxanes, preferably cyclopentane.

33. The system of claim 32, wherein the working fluid for the ORC power generation system is condensed in an air-cooled condenser.

34. The system of claim 30, wherein the WHRU is installed within an exhaust stack for transporting exhaust gas from the prime mover.

35. The system of claim 30, wherein the WHRU is installed in parallel to an exhaust stack for transporting exhaust gas from the prime mover.

36. The system of claim 30, wherein an exhaust gas inlet to the WHRU is provided at the bottom of the WHRU located in a vertically extending exhaust stack for transporting exhaust gas from the prime mover.

37. The system of claim 29, wherein water for electrolysis undergoes pre-treatment to reduce total dissolved solids and provide demineralised water for delivery to said electrolyser.

38. The system of claim 37, wherein said electrolyser is an alkaline electrolyser.

39. A pipeline system comprising:
a pipeline for transporting a fluid from a fluid producing location to a fluid use location;
a compressor station for transporting fluid through the pipeline and comprising a compressor driven by a prime mover, operation of the prime mover providing electricity to drive the compressor and an exhaust gas;
a waste heat to power system for recovering heat from said exhaust gas to produce baseload electricity;
an electrolyser connected to the waste heat to power system and continuously supplied with said baseload electricity from the waste heat to power system during operation of the prime mover to conduct electrolysis of water to produce a high-purity hydrogen product and oxygen; and
a hydrogen compression and delivery system for delivering hydrogen at least to the pipeline at a selected pressure
wherein the waste heat to power system is selected from the group consisting of an Organic Rankine Cycle (ORC) power generation system, supercritical CO₂ power generation system and Kalina power generation system.

40. The system of claim 39, wherein said hydrogen delivery system allows delivery of hydrogen to the pipeline to be blended with the fluid, said delivery of hydrogen to the pipeline optionally being by injection.

41. The system of claim 39, wherein said prime mover is a gas turbine utilising gas from the pipeline as fuel.

42. A system for producing hydrogen comprising:
a prime mover, operation of the prime mover providing an exhaust gas;
a waste heat to power system for recovering heat from said exhaust gas to produce baseload electricity;
an electrolyser continuously supplied with said baseload electricity from the waste heat to power system during operation of the prime mover to conduct electrolysis of water to produce hydrogen and oxygen; and
a hydrogen compression, storage and distribution system for separate storage and distribution of high-purity hydrogen product
wherein the waste heat to power system is selected from the group consisting of an Organic Rankine Cycle (ORC) power generation system, supercritical CO₂ power generation system and Kalina power generation system.

43. The system of claim 42, wherein said prime mover drives a compressor or an electricity generator.

44. The system of claim 43, wherein said compressor transports a fluid through a pipeline.

45. The system of claim 29, wherein said electrolyser is geographically co-located with the waste heat to power system.

46. The system of claim 29, wherein said electrolyser is located at another geographic location than the waste heat to power system.

47. The system of claim 29, wherein said electrolyser is partially supplied with electricity from said waste heat to power system.

48. The system of claim 26, wherein said electrolyser is supplied with baseload electricity from said waste heat to power system and with an intermittent source of electricity sourced from renewable sources.
